(19) United States
(12) Patent Application Publication
(10) Pub. No.: US 2025/0133522 A1
(43) Pub. Date: Apr. 24, 2025

(54) SYSTEMS AND METHODS TO FACILITATE LONG UPLINK TRANSMISSION IN INTERNET OF THINGS NON-TERRESTERIAL NETWORKS

(71) Applicant: Telefonaktiebolaget LM Ericsson (PUBL), Stockholm (SE)

(72) Inventors: Talha Khan, SANTA CLARA, CA (US); Xingqin Lin, SAN JOSÈ, CA (US); Stefan Eriksson Löwenmark, FÄRENTUNA (SE)

(21) Appl. No.: 18/708,254

(22) PCT Filed: Nov. 10, 2022
(86) PCT No.: PCT/SE2022/051045

§ 371 Date: May 8, 2024

Related U.S. Application Data
(60) Provisional application No. 63/278,068, filed on Nov. 10, 2021.

(51) Int. Cl. H04W 56/00; H04L 1/00; H04W 84/06

(52) U.S. Cl. CPC H04W 56/0045; H04L 1/0068; H04W 84/06

(57) ABSTRACT

A method (700) by a user equipment, UE, (112, 200) for facilitating long uplink transmission in an Internet of Things, IoT, Non-Terrestrial Network, NTN, includes transmitting (702), to a network node (110, 300), information for determining whether the UE is to insert at least one gap between adjacent transmission segments in at least one uplink transmission. The UE receives (704), from the network node, configuration information configuring the UE to insert the at least one gap when the information transmitted to the network node indicates that at least one symbol, slot, and/or subframe is to be dropped and/or punctured to implement segmented pre-compensation or not insert the at least one gap when the information transmitted to the network node indicates that at least one sample is to be dropped and/or punctured to implement segmented pre-compensation.

### TECHNICAL FIELD

The present disclosure relates, in general, to wireless communications and, more particularly, systems and methods to facilitate long uplink transmission in Internet of Things (IoT) Non-Terrestrial Networks (NTNs).

### BACKGROUND

In 3^{rd} Generation Partnership Project (3GPP) Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since 3GPP Release 13, Narrowband-Internet of Things (NB-IoT) and LTE-Machine Type Communication (LTE-M) are part of the LTE specifications and provide connectivity to massive machine type communications (mMTC) services.

In 3GPP Release 15, the first release of the 5G system (5GS) was specified. This is a new generation's radio access technology intended to serve use cases such as enhanced mobile broadband (eMBB), ultra-reliable and low latency communication (URLLC) and mMTC. 5G includes the New Radio (NR) access stratum interface and the 5G Core Network (5GC). The NR physical and higher layers are reusing parts of the LTE specification, and to that add needed components when motivated by the new use cases. One such component is the introduction of a sophisticated framework for beam forming and beam management to extend the support of the 3GPP technologies to a frequency range going beyond 6 GHz.

### Satellite Communication and Non-Terrestrial Networks

There is an ongoing resurgence of satellite communications. Several plans for satellite networks have been announced in the past few years. The target services vary, from backhaul and fixed wireless, to transportation, to outdoor mobile, to IoT. Satellite networks could complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest, which has been reflected in the 3GPP standardization work.

In 3GPP Release 15, 3GPP started the work to prepare NR for operation in a NTN. The work was performed within the study item “NR to support Non-Terrestrial Networks” and resulted in 3GPP TR 38.811 v. 15.4.0. See, TR 38.811 v. 15.4.0, Study on New Radio (NR) to support non-terrestrial networks. In 3GPP Release 16, the work to prepare NR for operation in an NTN network continued with the study item “Solutions for NR to support Non-Terrestrial Network”, which has been captured in 3GPP TR 38.821 v. 16.1.0. See, TR 38.821 v. 16.1.0, Solutions for NR to support non-terrestrial networks, 3GPP, 16.1.0, June 2021. In parallel, the interest to adapt Narrowband-IoT (NB-IoT) and LTE-Machine Type Communication (LTE-M) for operation in NTN is growing. As a consequence, 3GPP Release 17 contains a work item on NR NTN. See, RP-193234, Solutions for NR to support non-terrestrial networks (NTN), 3GPP RAN #86. 3GPP Release 17 also includes a study item on NB-IoT and LTE-M support for NTN. See, RP-193235, Study on NB-Io/eMTC support for Non-Terrestrial Network, 3GPP RAN #86.

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite
Access link, or service link, that refers to the link between a satellite and a user equipment (UE).

Depending on the orbit altitude, a satellite may be categorized as low earth orbit (LEO), medium earth orbit (MEO), or geostationary earth orbit (GEO) satellite:
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

Two basic architectures can be distinguished for satellite communication networks, depending on the functionality of the satellites in the system:
Transparent payload (also referred to as bent pipe architecture): The satellite forwards the received signal between the terminal and the network equipment on the ground with only amplification and a shift from uplink frequency to downlink frequency. When applied to general 3GPP architecture and terminology, the transparent payload architecture means that the gNodeB (gNB) is located on the ground and the satellite forwards signals/data between the gNB and the UE
Regenerative payload: The satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP Release 17, only the transparent payload architecture is considered.

FIG. 1 illustrates an example architecture of a satellite network with bent pipe transponders (i.e. the transparent payload architecture). The gNB may be integrated in the gateway or connected to the gateway via a terrestrial connection (wire, optic fiber, wireless link).

A communication satellite typically generates several beams over a given area. The footprint of a beam is usually in an elliptic shape, which has traditionally been considered as a cell, but cells consisting of the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

### Consequences of Long Propagation Delay/RTT and High Satellite Speed

Propagation delay is an important aspect of satellite communications that is different from the delay expected in a terrestrial mobile system. For a bent pipe satellite network, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between the UE and a satellite can vary significantly, depending on the position of the satellite and thus the elevation angle ε seen by the UE. Assuming circular orbits, the minimum distance is realized when the satellite is directly above the UE (ε=90°), and the maximum distance when the satellite is at the smallest possible elevation angle. TABLE 1 shows the distances between satellite and UE for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

TABLE 1
Propagation delay for different orbital heights and elevation angles.

| | | | | | One-way | | Propagation |
|---|---|---|---|---|---|---|---|
| Orbital | | Elevation | Distance | | propagation | | delay |
| height | | angle | UE <-> satellite | | delay | | difference |
| 600 | km | 90° | 600 | km | 2.0 | ms | — |

| | | | | | | |
|---|---|---|---|---|---|---|
| 30° | 1075 | km | 3.6 | ms | 1.6 | ms |
| 10° | 1932 | km | 6.4 | ms | 4.4 | ms |

| | | | | | | | |
|---|---|---|---|---|---|---|---|
| 1200 | km | 90° | 1200 | km | 4.0 | ms | — |

| | | | | | | |
|---|---|---|---|---|---|---|
| 30° | 1999 | km | 6.7 | ms | 2.7 | ms |
| 10° | 3131 | km | 10.4 | ms | 6.4 | ms |

| | | | | | | | |
|---|---|---|---|---|---|---|---|
| 35786 | km | 90° | 35786 | km | 119.4 | ms | — |

| | | | | | | |
|---|---|---|---|---|---|---|
| 30° | 38609 | km | 128.8 | ms | 9.4 | ms |
| 10° | 40581 | km | 135.4 | ms | 16.0 | ms |

The propagation delay may also be highly variable due to the high velocity of the LEO and MEO satellites and change in the order of 10-100 μs every second, depending on the orbit altitude and satellite velocity.

For NTNs using 3GPP technology, in particular 5G/NR, the long propagation delay means that the timing advance (TA) the UE uses for its uplink transmissions is essential and has to be much greater than in terrestrial networks in order for the uplink and downlink to be time aligned at the gNB, as is the case in NR and LTE. One of the purposes of the random access (RA) procedure is to provide the UE with a valid TA, which the network later can adjust based on the reception timing of uplink transmission from the UE. However, even the RA preamble (i.e. the initial message from the UE in the RA procedure) has to be transmitted with a TA to allow a reasonable size of the RA preamble reception window in the gNB (and to ensure that the cyclic shift of the preamble's Zadoff-Chu sequence is not so large that it makes the Zadoff-Chu sequence and, thus, the preamble appear as if it is another Zadoff Chu sequence and, thus, another preamble based on the same Zadoff-Chu root sequence). However, this TA does not have to be as accurate as the TA the UE subsequently uses for other uplink transmissions. The TA the UE uses for the RA preamble transmission in NTN is called “pre-compensation TA.” Various proposals have been considered for how to determine the pre-compensation TA—all of which involves information originating both at the gNB and at the UE. In brief, the discussed alternative proposals include:
The network broadcasts a “common TA” that is valid at a certain reference point such as, for example, a center point in the cell. The UE would then calculate how its own pre-compensation TA deviates from the common TA, based on the difference between the UE's own location and the reference point together with the position of the satellite. According to this method, the UE acquires its own position using Global Navigation Satellite System (GNSS) measurements and obtains the satellite position using satellite orbital data (including satellite position at a certain time) that is broadcast by the network.
The UE autonomously calculates the propagation delay between the UE and the satellite based on the UE's and the satellite's respective positions, and the network/gNB broadcasts the propagation delay on the feeder link, i.e. the propagation delay between the gNB and the satellite. According to this method, the UE acquires its own position using GNSS measurements and obtains the satellite position using satellite orbital data (including satellite position at a certain time) that is broadcast by the network. The pre-compensation TA is then calculated as twice the sum of the propagation delay on the feeder link and the propagation delay between the satellite and the UE.
The gNB broadcasts a timestamp (in System Information Block 9 (SIB9)), which the UE compares with a reference timestamp acquired from GNSS. Based on the difference between these two timestamps, the UE can calculate the propagation delay between the gNB and the UE, and the pre-compensation TA is twice as long as this propagation delay.

In conjunction with the RA procedure, the gNB provides the UE with an accurate (i.e. fine-adjusted) TA in the Random Access Response message (in 4-step RA) or MsgB (in 2-step RA), based on the time of reception of the RA preamble. The gNB can subsequently adjust the UE's TA using a Timing Advance Command MAC CE (or an Absolute Timing Advance Command MAC CE), based on the timing of receptions of uplink transmissions from the UE. A goal with such network control of the UE's TA is typically to keep the time error of the UE's uplink transmissions at the gNB's receiver within the cyclic prefix (as is required for correct decoding of the uplink transmissions). The TA control framework also includes a time alignment timer that the gNB configures the UE with. The time alignment timer is restarted every time the gNB adjusts the UE's TA and if the time alignment timer expires, the UE is not allowed to transmit in the uplink without a prior RA procedure, which serves the purpose of providing the UE with a valid timing advance. For NTN, 3GPP has also agreed that, in addition to the gNB's control of the UE's TA, the UE is allowed to autonomously update its TA based on estimation of changes in the UE-gNB Round-Trip-Time (RTT) using the UE's location (e.g. obtained from GNSS measurement) and knowledge of the serving satellite's ephemeris data and feeder link delay information from the gNB.

A second relevant aspect is that, not only is the propagation delay between the UE and a satellite, or between the UE and a gNB, very long in NTN, but due to the large distances, the difference in propagation delay between two different satellites or two different gNBs, may be significant on the timescales relevant for cellular communication, including signaling procedures, even when the satellites/gNBs serve neighboring cells. This has an impact on all procedures involving reception or transmission in two cells served by different satellites and/or different gNBs.

A third important aspect related to the long propagation delay/RTT in Non-Terrestrial Networks is the introduction of an additional parameter to compensate for the long propagation delay/RTT. In terrestrial cellular networks, the UE-gNB RTT may range from nearly zero to several tens of microseconds in a cell. A major difference in Non-Terrestrial Networks, apart from the sheer size of the propagation delay/RTT, is that even at the location in the cell where the propagation delay/RTT is the smallest, the propagation delay/RTT will be large and nowhere close to zero. In fact, the variation of the propagation delay/RTT within a NTN cell is small compared to the propagation delay/RTT. This speaks in favor of introducing an offset that essentially takes care of the RTT between the cell's footprint on the ground and the satellite, while other mechanisms, including signaling and control loops, take care of the RTT dependent aspects within the smaller range of RTT variation within the cell on top of the offset. To this end, 3GPP has agreed to introduce such a parameter, which is denoted K_{offset} (or sometimes K_offset).

The K_{offset} parameter may potentially be used in various timing related mechanisms, but the application relevant herein uses it in the scheduling of uplink transmissions on the Physical Uplink Shared Channel (PUSCH). K_{offset} is used to indicate an additional delay between the uplink grant (UL grant) and the PUSCH transmission resources allocated by UL grant to be added to the slot offset parameter K₂ in the Downlink Control Information (DCI) containing the UL grant. The offset between the UL grant and the slot in which the PUSCH transmission resources are allocated is thus K_{offset}+K₂. When used this way in uplink scheduling, K_{offset} can be said to serve the purpose of ensuring that the UE is never scheduled to transmit at a point in time that, due to the large TA the UE has to apply, would occur before the point in time when the UE receives the UL grant. In 3GPP, it has also been discussed to let the network's configuration of K_{offset} take into account the TA that the UE may have signaled that the UE has used.

A fourth important aspect closely related to the timing is a Doppler frequency offset induced by the motion of the satellite. The access link may be exposed to Doppler shift in the order of 10-100 kHz in sub-6 GHz frequency band and proportionally higher in higher frequency bands. Also, the Doppler shift is varying, with a rate of up to several hundred Hz per second in the S-band and several kHz per second in the Ka-band.

### Ephemeris Data

In 3GPP TR 38.821 v. 16.1.0, it has been captured that ephemeris data should be provided to the UE, for example, to assist with pointing a directional antenna (or an antenna beam) towards the satellite and to calculate a correct TA and Doppler shift. Procedures on how to provide and update ephemeris data have not yet been studied in detail, but broadcasting of ephemeris data in the system information is one option.

A satellite orbit can be fully described using six parameters. Exactly which set of parameters is chosen can be decided by the user, and many different representations are possible. For example, a choice of parameters used often in astronomy is the orbital set (a, ε, i, Ω, ω, t), which is illustrated in FIG. 2. As depicted, the semi-major axis a and the eccentricity ε describe the shape and size of the orbit ellipse; the inclination i, the right ascension of the ascending node Ω, the argument of periapsis ω determine its position in space, and the epoch t determines a reference time (e.g., the time when the satellites moves through periapsis).

As an example of a different parametrization, the Two-Line Elements (TLEs) use mean motion n and mean anomaly M instead of a and t. A completely different set of parameters is the position and velocity vector (x, y, z, vₓ, v_{y}, v_{z}) of a satellite. These are sometimes called orbital state vectors. They can be derived from the orbital elements and vice versa, since the information they contain is equivalent. All these formulations (and many others) are possible choices for the format of ephemeris data to be used in NTN. To enable further progress, the format of the data should be agreed upon.

It is important that a UE can determine the position of a satellite with accuracy of at least a few meters. However, several studies have shown that this might be hard to achieve when using the de-facto standard of TLEs. On the other hand, LEO satellites often have GNSS receivers and can determine their position with some meter level accuracy.

Another aspect discussed during the study item and captured in 3GPP TR 38.821 v. 16.1.0 is the validity time of ephemeris data. In general, predictions of satellite positions degrade with increasing age of the ephemeris data that is used. This is due to atmospheric drag, maneuvering of the satellite, imperfections in the orbital models used, etc. Therefore, publicly available TLE data is updated quite frequently, for example. The update frequency depends on the satellite and its orbit and ranges from weekly to multiple times a day for satellites on very low orbits that are exposed to strong atmospheric drag and need to perform correctional maneuvers often.

So, while it seems possible to provide the satellite position with the required accuracy, care needs to be taken to meet these requirements. For example, care needs to be taken when choosing the ephemeris data format or the orbital model to be used for the orbital propagation.

### Some Outcome of the 3GPP Study Items on NTN

The outcome of the study items in 3GPP lay the foundation for the specification work of NTNs in 3GPP. The following includes some relevant information from the study items and the resulting technical reports discussed above:
The coverage pattern of NTN is described in Section 4.6 of 3GPP TR 38.811 v. 15.4.0 as follows:
Satellite or aerial vehicles typically generate several beams over a given area. The foot print of the beams are typically elliptic shape.
The beam footprint may be moving over the earth with the satellite or the aerial vehicle motion on its orbit. Alternatively, the beam foot print may be earth fixed, in such case some beam pointing mechanisms (mechanical or electronic steering feature) will compensate for the satellite or the aerial vehicle motion.

Typical beam footprint sizes are listed in Table 2, which corresponds with Table 4.5.1 of Section 4.6 of 3GPP TR 38.811 v. 15.4.0.

TABLE 2
Typical beam footprint size [1]

| Attributes | GEO | Non-GEO | Aerial |
|---|---|---|---|
| Beam foot print | 200-1000 km | 100-500 km | 5-200 km |
| size in diameter | | | |

FIG. 3 illustrates typical beam patterns of various NTN access networks as discussed in 3GPP TR 38.811 v. 15.4.0.

The TR of the second study item, 3GPP TR 38.821 v. 16.1.0, describes scenarios for the NTN work as follows:

Non-Terrestrial Network typically features the following elements:
One or several sat-gateways that connect the Non-Terrestrial Network to a public data network
   a GEO satellite is fed by one or several sat-gateways which are deployed across the satellite targeted coverage (e.g. regional or even continental coverage). We assume that UE in a cell are served by only one sat-gateway
   A Non-GEO satellite served successively by one sat-gateway at a time. The system ensures service and feeder link continuity between the successive serving sat-gateways with sufficient time duration to proceed with mobility anchoring and hand-over

Four scenarios are considered as depicted in Table 3 and are detailed in Table 4, which correspond to Table 4.2-1 and Table 4.2-2 of 3GPP TR 38.821 v. 16.1.0, respectively.

TABLE 3
Reference scenarios

| | Transparent | Regenerative |
|---|---|---|
| | satellite | satellite |
| GEO based non-terrestrial access network | Scenario A | Scenario B |
| LEO based non-terrestrial access network | Scenario C | Scenario D |

TABLE 4
Reference scenario parameters

| | Scenarios | | | |
|---|---|---|---|---|
| | | | LEO based non-terrestrial | |
| | GEO based non-terrestrial access | | access network | |
| | network (Scenario A and B) | | (Scenario C & D) | |
| Orbit type | Notional station keeping position | | Circular orbiting around | |
| | fixed in terms of elevation/azimuth | | the earth | |
| | with respect to a given earth point | | | |
| Altitude | 35,786 | km | 600 | km |
| | | | 1,200 | km |
| Spectrum (service link) | <6 GHz (e.g. 2 GHz) | | | |
| | >6 GHz (e.g. DL 20 GHz, UL 30 GHz) | | | |
| Max channel bandwidth | 30 MHz for band < 6 GHz | | | |
| (service link) | 400 MHz for band > 6 GHz | | | |
| Payload | Scenario A : Transparent (including | | Scenario C: Transparent | |
| | radio frequency function only) | | (including radio frequency | |
| | Scenario B: regenerative (including | | function only) | |
| | all or part of RAN functions) | | Scenario D: Regenerative | |
| | | | (including all or part of | |
| | | | RAN functions) | |
| Inter-Satellite link | No | | Scenario C: No | |
| | | | Scenario D: Yes | |
| Earth-fixed beams | Yes | | Scenario C: No (the beams | |
| | | | move with the satellite) | |
| | | | Scenario D, option 1: Yes | |
| | | | (steering beams), see | |
| | | | note 1 | |
| | | | Scenario D, option 2: No | |
| | | | (the beams move with the | |
| | | | satellite) | |
| Max beam foot print | 500 | km | 200 | km |
| diameter at nadir | | | | |
| Min Elevation angle for both | 10° | | 10° | |
| sat-gateway and user | | | | |
| equipment | | | | |
| Max distance between | 40,586 | km | 1,932 km (600 km altitude) | |
| satellite and user equipment | | | 3,131 km (1,200 km | |
| at min elevation angle | | | altitude) | |
| Max Round Trip Delay | Scenario A: 562 ms (service and | | Scenario C: 25.76 ms | |
| (propagation delay only) | feeder links) | | (transparent payload: | |
| | Scenario B: 281 ms | | service and feeder links) | |
| | | | Scenario D: 12.88 ms | |
| | | | (regenerative payload: | |
| | | | service link only) | |
| Max delay variation within a | 16 | ms | 4.44 ms (600 km) | |
| beam (earth fixed user | | | 6.44 ms (1200 km) | |
| equipment) | | | | |
| Max differential delay within | 1.6 | ms | 0.65 | ms (*) |
| a beam | | | | |
| Max Doppler shift (earth | 0.93 | ppm | 24 | ppm (*) |
| fixed user equipment) | | | | |
| Max Doppler shift variation | 0.000 045 | ppm/s | 0.27 | ppm/s (*) |

| (earth fixed user equipment) | | |
|---|---|---|
| User equipment motion on | 1000 km/h (e.g. aircraft) | 500 km/h (e.g. high speed |
| the earth | | train) |
| | | Possibly 1000 km/h (e.g. |
| | | aircraft) |
| User equipment antenna | Omnidirectional antenna (linear polarisation), assuming 0 dBi | |
| types | Directive antenna (up to 60 cm equivalent aperture | |
| | diameter in circular polarisation) | |
| User equipment Tx power | Omnidirectional antenna: UE power class 3 with up to 200 mW | |
| | Directive antenna: up to 4 W | |
| User equipment Noise figure | Omnidirectional antenna: 7 dB | |
| | Directive antenna: 1.2 dB | |
| Service link | 3GPP defined New Radio | |
| Feeder link | 3GPP or non-3GPP defined Radio | 3GPP or non-3GPP defined |
| | interface | Radio interface |

It is noted that each satellite has the capability to steer beams towards fixed points on earth using beamforming techniques. This is applicable for a period of time corresponding to the visibility time of the satellite. Max delay variation within a beam (earth fixed user equipment) is calculated based on Min Elevation angle for both gateway and user equipment. Max differential delay within a beam is calculated based on Max beam foot print diameter at nadir.

For scenario D, which is LEO with regenerative payload, both earth-fixed and earth moving beams have been listed. So, when we factor in the fixed/non-fixed beams, there is an additional scenario. The complete list of 5 scenarios in 3GPP TR 38.821 v. 16.1.0 is then:
Scenario A—GEO, transparent satellite, Earth-fixed beams;
Scenario B—GEO, regenerative satellite, Earth fixed beams;
Scenario C—LEO, transparent satellite, Earth-moving beams;
Scenario D1—LEO, regenerative satellite, Earth-fixed beams;
Scenario D2—LEO, regenerative satellite, Earth-moving beams.

### Segmented Pre-Compensation for Long Uplink Transmission

In Rel-17 IoT NTN Work Item (WI), it has been agreed to introduce segmented pre-compensation for uplink transmission for long uplink transmission. Previously, the UE would adjust its uplink timing at the start of the transmission. For IoT NTN, the network may configure the UE with a transmission segment of a certain duration, and the UE can adjust its timing and frequency at the start of every such transmission segment. This feature has been introduced to compensate for large timing and frequency drift in NTN scenarios (e.g., LEO).

In the 3GPP RAN1 #106-e meeting, the following agreements were made for segmented pre-compensation for long UL transmission:
Agreement: Duration of uplink (UL) transmission segment for UE pre-compensation for Physical Random Access Channel (PRACH) transmission is a number of Random Access Channel (RACH) repetition units configured by the network
   For NB-IoT, repetition unit is P symbol groups.
   For Enhanced Machine Type Communication (eMTC), repetition unit is one preamble including guard period.
   For Future Study (FFS): Configuration details
Agreement: Duration of UL transmission segment for UE pre-compensation for PUSCH transmission is a number of PUSCH repetition units configured by the network:
   For NB-IoT, repetition unit is M_{identical}^{NPUSCH}×Nₛₗₒₜ^{UL}×Tₛₗₒₜ
   For eMTC, repetition unit is Nₛₗₒₜ^{UL}×Tₛₗₒₜ for sub-Physical Resource Block (sub-PRB) allocation, where Tₛₗₒₜ=0.5 ms. For full-Physical Resource Block (full-PRB) allocation, repetition unit is one subframe.
   NOTE1: M_{identical}^{NPUSCH}, Nₛₗₒₜ^{UL}, Tₛₗₒₜ are defined in TS 36.211 10.1.2.3 and 10.1.3.6 for NB-IoT.
   NOTE2: M_\hat{ }UL_slot is defined in TS 36.211, 5.2.3A for eMTC
   FFS: RAN1 to further discuss valid and invalid subframes
   FFS: Configuration details
Agreement: For NB-IoT, if a mapping to Nₛₗₒₜₛ slots or a repetition of the mapping in an UL transmission segment for UE pre-compensation for Narrowband PUSCH (NPUSCH) transmission contains a resource element which overlaps with any configured Narrowband Physical Random Access Channel (NPRACH) resource, the NPUSCH transmission in overlapped Nₛₗₒₜₛ slots is postponed until the next Nₛₗₒₜₛ slots not overlapping with any configured NPRACH resource.
NOTE: Nₛₗₒₜₛ is defined in TS 36.211, 10.1.3.6
Agreement: The UL transmission segment duration is configured by the network
   FFS: Details of the configuration signalling.
Agreement:
   For NB-IoT NTN, the network configures one of K values for the UL transmission segment duration of each PRACH preamble format in a k-bit field, where the size of the k-bit field and the number of K candidate values depend on the preamble format.
      Format 0 and format 1:3-bit field, K=6 candidate values 2.4.(T_{CP}+T_{SEQ}), 4.4.(T_{CP}+T_{SEQ}), 8.4.(T_{CP}+T_{SEQ}), 16.4.(T_{CP}+T_{SEQ}), 32.4.(T_{CP}+T_{SEQ}), 64.4.(T_{CP}+T_{SEQ})
      Format 2:2-bit field, K=4 candidate values 2.6.(T_{CP}+T_{SEQ}), 4.6.(T_{CP}+T_{SEQ}), 8.6.(T_{CP}+T_{SEQ}), 16.6.(T_{CP}+T_{SEQ})
   FFS: Down scoping of K candidate values, size of k-bit field
   FFS: Whether the same segment duration can be used for all preambles within a preamble format
Agreement:
   For eMTC, the network configures one of K values for the UL transmission segment duration of PRACH in a k-bit field.
   FFS: K candidate values, size of k-bit field
Agreement:
   For NB-IoT/eMTC NTN, the network configures one of K candidate values for the UL transmission segment duration of NPUSCH/PUSCH in a k-bit field.
      For NB-IoT, maximum 3-bit field with a maximum number of K=8 candidate values 2 ms, 4 ms, 8 ms, 16 ms, 32 ms, 64 ms, 128 ms, 256 ms
   FFS: Down scoping of K candidate values, size of k-bit field
Agreement:
   The UL transmission segment duration is provided by UE-specific Radio Resource Control (RRC) signalling or by signalling in System Information Block (SIB).
   NOTE: the values of UL transmission segment duration for NB-IoT can be different to those for eMTC.

In 3GPP RAN1 #106-bis-e meeting, the following agreements were made for segmented pre-compensation for long UL transmission:
Agreement: Configuration of UL transmission segment is indicated on System Information Block (SIB) at least for initial access
   FFS via UE-specific RRC signalling in RRC_CONNECTED.
Agreement: For eMTC PUSCH, a 3-bit field to indicate K=8 values for the uplink transmission segment duration:
   Full-PRB allocation (unit: subframes): 2 4 8 16 32 64 128 256
   Sub-PRB allocation (unit: resource units): 1 2 4 8 16 32 64 128
Agreement: For eMTC, a 3-bit field is defined in the SIB to indicate the following K=8 values for the UL transmission segment duration of PRACH:
   (T_{CP}+T_{SEQ}+T_{GP}), 2*(T_{CP}+T_{SEQ}+T_{GP}), 4*(T_{CP}+T_{SEQ}+T_{GP}), 8*(T_{CP}+T_{SEQ}+T_{GP}), 16*(T_{CP}+T_{SEQ}+T_{GP}), 32*(T_{CP}+T_{SEQ}+T_{GP}), 64*(T_{CP}+T_{SEQ}+T_{GP}), 128*(T_{CP}+T_{SEQ}+T_{GP})
Agreement: For eMTC, the same value is used for segment durations for all PRACH preambles
Agreement: For NB-IoT, the same value is used for segment durations for all NPRACH preambles for a particular NPRACH format

There currently exist certain challenge(s), however. For example, the TA and frequency error due to large timing and frequency drift can be very high in Non-Geostationary Orbit (NGSO) satellites, especially LEO scenarios. In Rel-17 IoT NTN WI, segmented pre-compensation will be introduced for such long UL transmissions. For example, the UE can adjust its UL transmit timing and frequency at the start of every transmission segment during an UL ongoing transmission. Therefore, methods and signalling are needed to facilitate segmented pre-compensation while accounting for different UE capabilities.

### SUMMARY

Certain aspects of the disclosure and their embodiments may provide solutions to these or other challenges. For example, methods and systems are provided to support different types of UE capabilities with respect to segmented pre-compensation for IoT NTN. Additionally or alternatively, certain methods and systems map provide TA-dependent gap configuration to minimize the need of inserting uplink gaps for segmented pre-compensation.

According to certain embodiments, a method by a UE for facilitating long uplink transmission in an IoT NTN includes transmitting, to a network node, information for determining whether the UE is to insert at least one gap between adjacent transmission segments in at least one uplink transmission. The UE receives, from the network node, configuration information configuring the UE to insert the at least one gap when the information transmitted to the network node indicates that at least one symbol, slot, and/or subframe is to be dropped and/or punctured to implement segmented pre-compensation. Alternatively, the configuration information configures the UE to not insert the at least one gap when the information transmitted to the network node indicates that at least one sample is to be dropped and/or punctured to implement segmented pre-compensation.

According to certain embodiments, a UE for facilitating long uplink transmission in an IoT NTN includes processing circuitry configured to transmit, to a network node, information for determining whether the UE is to insert at least one gap between adjacent transmission segments in at least one uplink transmission. The processing circuitry is configured to receive, from the network node, configuration information configuring the UE to insert the at least one gap when the information transmitted to the network node indicates that at least one symbol, slot, and/or subframe is to be dropped and/or punctured to implement segmented pre-compensation. Alternatively, the configuration information configures the UE to not insert the at least one gap when the information transmitted to the network node indicates that at least one sample is to be dropped and/or punctured to implement segmented pre-compensation.

According to certain embodiments, a method by a network node for facilitating long uplink transmission in an IoT NTN includes receiving, from a UE, information for determining whether the UE is to insert at least one gap between adjacent transmission segments in at least one uplink transmission. Based on the information, the network node configures the UE to insert the at least one gap when the information indicates that at least one symbol, slot, and/or subframe is to be dropped and/or punctured to implement segmented pre-compensation. Alternatively, the network node configures the UE to not insert the at least one gap when the information indicates that at least one sample is to be dropped and/or punctured to implement segmented pre-compensation.

According to certain embodiments, a network node includes processing circuitry configured to receive, from a UE, information for determining whether the UE is to insert at least one gap between adjacent transmission segments in at least one uplink transmission. Based on the information, the processing circuitry is configured to configure the UE to insert the at least one gap when the information indicates that at least one symbol, slot, and/or subframe is to be dropped and/or punctured to implement segmented pre-compensation. Alternatively, the network node configures the UE to not insert the at least one gap when the information indicates that at least one sample is to be dropped and/or punctured to implement segmented pre-compensation.

Certain embodiments may provide one or more of the following technical advantage(s). For example, certain embodiments may provide a technical advantage of supporting different types of UE capabilities with respect to segmented pre-compensation for IoT NTN. As another example, certain embodiments may provide a technical advantage of minimizing the need for inserting uplink gaps for segmented pre-compensation.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example architecture of a satellite network with bent pipe transponders;

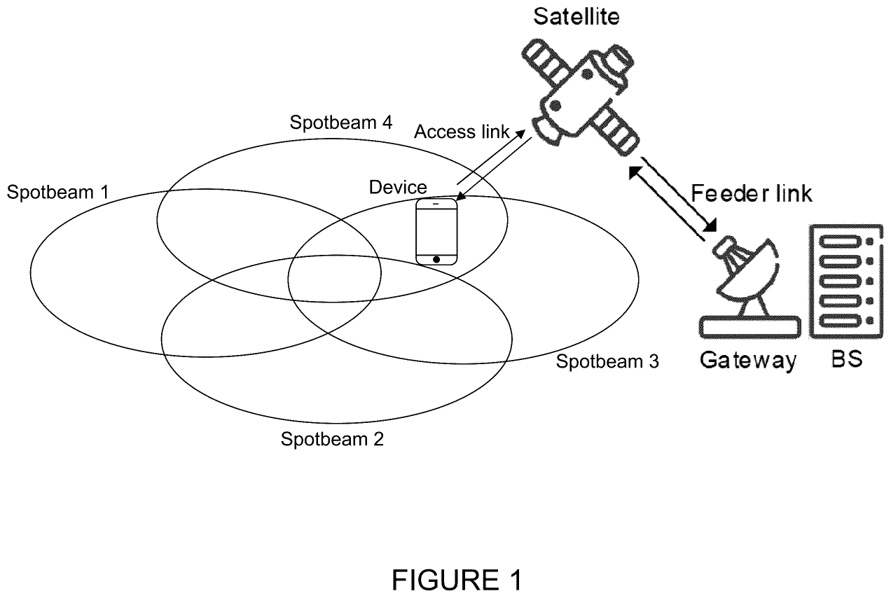

FIG. 2 illustrates an example orbital set;

FIG. 3 illustrates typical beam patterns of various NTN access networks as discussed in 3GPP TR 38.811 v. 15.4.0;

FIG. 4 illustrates an example communication system, according to certain embodiments;

FIG. 5 illustrates an example UE, according to certain embodiments;

FIG. 6 illustrates an example network node, according to certain embodiments;

FIG. 7 illustrates a block diagram of a host, according to certain embodiments;

FIG. 8 illustrates a virtualization environment in which functions implemented by some embodiments may be virtualized, according to certain embodiments;

FIG. 9 illustrates a host communicating via a network node with a UE over a partially wireless connection, according to certain embodiments;

FIG. 10 illustrates an example method by a UE for facilitating long UL transmission in an IoT NTN, according to certain embodiments; and

FIG. 11 illustrates an example method by a network node for facilitating long UL transmission in an IoT NTN, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As described above, in Rel-17 IoT NTN WI, it has been agreed to introduce transmission segments for UL pre-compensation. A UE can autonomously adjust its TA (and/or frequency) for UL transmission at the start of every transmission segment. The network will indicate the transmission segment configuration at least using SIB.

The following definitions are used to explain the embodiments disclosed herein:
Type-A UE: It requires a gap to be inserted between adjacent transmission segments to implement segmented uplink pre-compensation.
Type-B UE: It does not require a gap to be inserted between adjacent transmission segments to implement segmented uplink pre-compensation. It can for instance implement it by dropping/inserting samples or puncturing symbols, etc.

In a particular embodiment, for Type-B UEs, the number of samples or symbols or slots or subframes or resource units to be dropped to implement segmented pre-compensation is fixed in the standard specification.

In another particular embodiment, multiple values for the number of samples or symbols or slots or subframes or resource units (to be dropped or punctured) can be defined in the specification. The network can indicate the supported value or subset of values (from those defined in the specification) using the System Information (SI) or UE-specific RRC signalling. It is noted that the network does not need to insert a gap between transmission segments for Type-B UEs.

If UL gaps are introduced for segmented precompensation, it will complicate scheduling, especially if the need for gaps depends on UE capability (i.e., Type-A or Type-B UE). Further, the gaps will be difficult to utilize for scheduling UL transmissions from other UEs if they are short (e.g., 1 ms) and scattered.

If UL gaps are needed e.g. for Type-B UEs, an alternative approach that may reduce the impact on the scheduler is that the gaps are created by the UE by blanking the UL subframes at regular intervals (which can be fixed in the specification or configured by the network), thereby reducing the number of repetitions instead of spreading them out in time. Then, the scheduler can allocate the same UL resources regardless of whether the UE needs gaps or not.

The ideas described herein are applicable to LTE-M NTN and NB-IoT NTN uplink channels such as, for example Narrowband Physical Uplink Shared Channel ((N)PUSCH), Narrowband Physical Random Access Channel ((N) PRACH), and Physical Uplink Control Channel (PUCCH) but may be applicable to other UL channels as well.

The transmission segment duration or segment duration refers to the time duration of the transmission segment configured by the network for segmented uplink pre-compensation.

### UE Capability Signalling

In one embodiment, the UE signals whether it is a Type-A UE or Type-B UE to the network.

In a further particular embodiment, a Type-A UE signals the gap duration that it needs to insert between adjacent segments to implement segmented uplink pre-compensation. A value range for possible gap durations can be specified in the specification and/or indicated by the network in the SI.

In a further particular embodiment, a Type-B UE signals to the network the number of samples or symbols or slots or subframes or resource units that it needs to drop/puncture in order to implement segmented pre-compensation.

In another particular embodiment, the UE capability signaling depends on the type of physical channels. For example, an NB-IoT UE may signal that it requires a gap for NPUSCH transmission but does not require a gap for NPRACH transmission. Similarly, an eMTC UE may signal it requires a gap for PUSCH/PUCCH transmission but does not require a gap for PRACH transmission.

In another particular embodiment, the UE capability signaling depends on the duration of the transmission of physical channels. For example, a UE may report:
It does not need a gap between adjacent transmission segments
It does not need a gap between adjacent transmission segments within a certain duration of e.g., 256 ms, but it needs to use a gap after each transmission of 256 ms. It can additionally signal whether the needed gap can be the legacy UL compensation gap of 40 ms or a gap with a duration different from 40 ms.
It needs a gap between adjacent transmission segments within a certain duration of e.g., 256 ms.

In another particular embodiment, the UE capability signaling depends on the NTN type or satellite orbit. For example, a UE may report
It does not need a gap between adjacent transmission segments for GEO satellite network.
It needs a gap between adjacent transmission segments for LEO/MEO satellite network.

### TA-Dependent Gap Configuration

According to certain embodiments, the UE may need to insert gaps between adjacent transmission segments to implement timing/frequency pre-compensation. In a particular embodiment, the network may schedule and/or instruct the UE as to where the UE is to insert gaps. In another embodiment, the UE can choose where to insert the gap on its own (i.e., between those adjacent segments the UE likes). The UE may then inform the network where the gaps have been placed by the UE. Providing the information to the network may avoid blind detection and simplify scheduling.

In a particular embodiment, the UE inserts a gap between adjacent transmission segments depending on whether the TA is increasing or decreasing. If the TA is non-increasing, it will not insert gaps between segments; if the TA is increasing, it will insert gaps between adjacent segments. For example, based on satellite ephemeris and GNSS position information, the UE can determine if the satellite is moving towards the UE and/or if the satellite-UE elevation angle is increasing. In other words, the satellite-UE TA will decrease with time during the course of uplink transmission. The UE will not insert additional gaps between adjacent segments.

In a particular embodiment, depending on whether the TA is increasing or decreasing, the UE indicates it to the network if it will be inserting gaps between adjacent transmission segments of the ongoing UL transmission.

In another particular embodiment, the UE provides information to the UE so that the network may determine if the UE will use gaps and then detect accordingly. For example, in a particular embodiment, the UE reports its position to the network, and the network determines whether the TA is increasing or decreasing based on satellite ephemeris and the received UE position. The network derives that, if the TA is non-increasing, the UE does not insert gaps. Otherwise, if the TA is increasing, the network derives that the UE inserts gaps.

In another particular embodiment, the UE reports its TA to the network, and the network determines whether the TA is increasing or decreasing based on the received TA values. The network derives that if the TA is non-increasing, UE does not insert gaps. Otherwise, if the TA is increasing, UE inserts gaps. Accordingly, in a particular embodiment, the network may signal to the UE that the UE is to insert gaps based on the network's determination that the TA is increasing, for example.

### MSG3 (N)PUSCH and PUCCH to Msg4/NPUSCH Format 2 to Msg4

The following embodiments pertain to the case where the network configures transmission segment duration for MSG3 transmission on PUSCH/NPUSCH, or Hybrid Automatic Repeat Request-Acknowledgement (HARQ-ACK) transmission on PUCCH to Msg4 reception/HARQ-ACK on NPUSCH format 2 to Msg4 reception.

In one embodiment, it is specified in the standard specification that the UE inserts gaps between adjacent transmission segments for MSG3 transmission on PUSCH/NPUSCH or HARQ-ACK transmission on PUCCH to Msg4 reception/HARQ-ACK on NPUSCH format 2 to Msg4 reception. The duration of gap is fixed in the specification. Alternatively, it can be configured by the network from a set of values defined in the specification, and the configured gap duration can be indicated by the network in SI.

For example, if transmission segments are configured in a cell, all UEs insert gaps of indicated duration for MSG3 transmission on PUSCH between adjacent segments regardless of UE capability.

In another embodiment, it is specified in the standard specification that the UE should not insert gaps between adjacent transmission segments for MSG3 transmission on PUSCH/NPUSCH, or HARQ-ACK transmission on PUCCH to Msg4 reception/HARQ-ACK on NPUSCH format 2 to Msg4 reception.
If the network configures the UE with N repetitions for MSG3, or PUCCH/NPUSCH format 2 to Msg4 reception, the UE behavior for Type-A UEs is to transmit MSG3, or PUCCH/NPUSCH format 2 to Msg4 reception, using min (N, M) repetitions where M is the maximum number of repetitions it can transmit before requiring uplink pre-compensation. M can be indicated by the network in System Information (SI) or specified in the specification or M is equal to the duration of a segment. Thus, in a particular embodiment, the UE only transmits M repetitions. In another embodiment, however, the UE may not transmit all of the N repetitions where M is less than N. In still another embodiment, the UE may insert a gap and then transmit the rest of the N-M repetitions. In yet another embodiment, the UE may use one repetition as a gap after the first M repetitions and then continue to transmit N−M−1 repetitions.
If the network configures the UE with N repetitions for MSG3, or PUCCH/NPUSCH format 2 to Msg4 reception, the UE behavior for Type-B UEs is to transmit MSG3, or PUCCH/NPUSCH format 2 to Msg4 reception, using N repetitions. Thus, the Type-B UE drops samples or punctures symbols (as described above) as needed to be able to transmit all N repetitions, in an example embodiment.

In another embodiment, Type-A UEs insert specified or indicated gap between transmission segments for MSG3 transmission on PUSCH/NPUSCH (or PUCCH/NPUSCH format 2 to Msg4 reception) and Type-B UEs do not insert a gap between transmission segments for MSG3 transmission on PUSCH/NPUSCH (or PUCCH/NPUSCH format 2 to Msg4 reception). Network receives the UE transmissions by blind detection, if the network does not know the UE capability yet. For example, the network may perform multiple attempts to receive the UE transmissions to cover all possible options. In other words, the network may assume both that the UE is using a gap and that it is not using a gap to blindly detect the UE transmissions.

In a sub-embodiment, PRACH resources (time/frequency/code domain) are partitioned for Type-A and Type-B UEs, i.e., they use different PRACH resources so that the network knows the UE capability and can schedule MSG3 accordingly and can determine if MSG3 transmission will include gaps or not. As used here, PRACH resources may include resources for the random access preamble (Msg1).

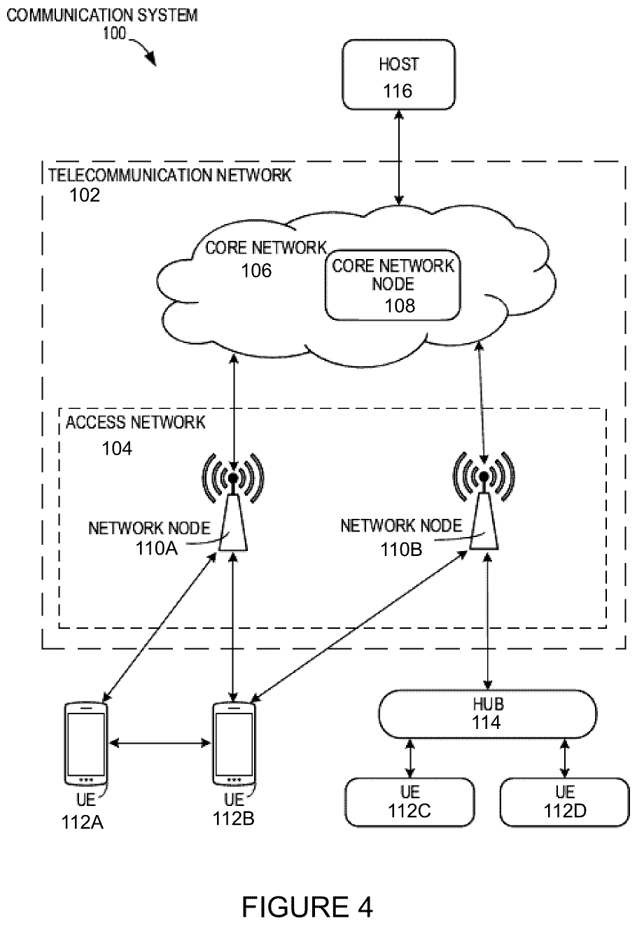

FIG. 4 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

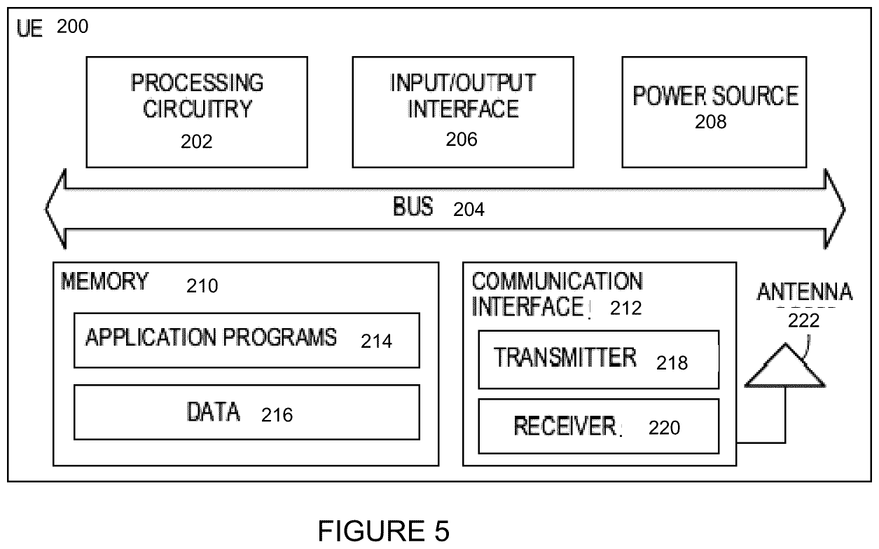

FIG. 5 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

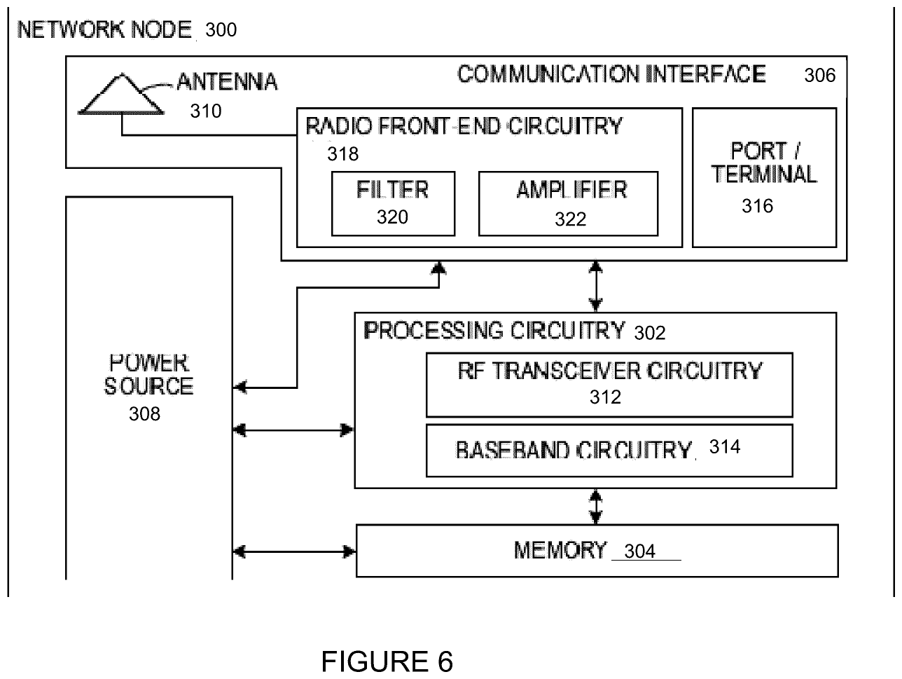

FIG. 6 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 6 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

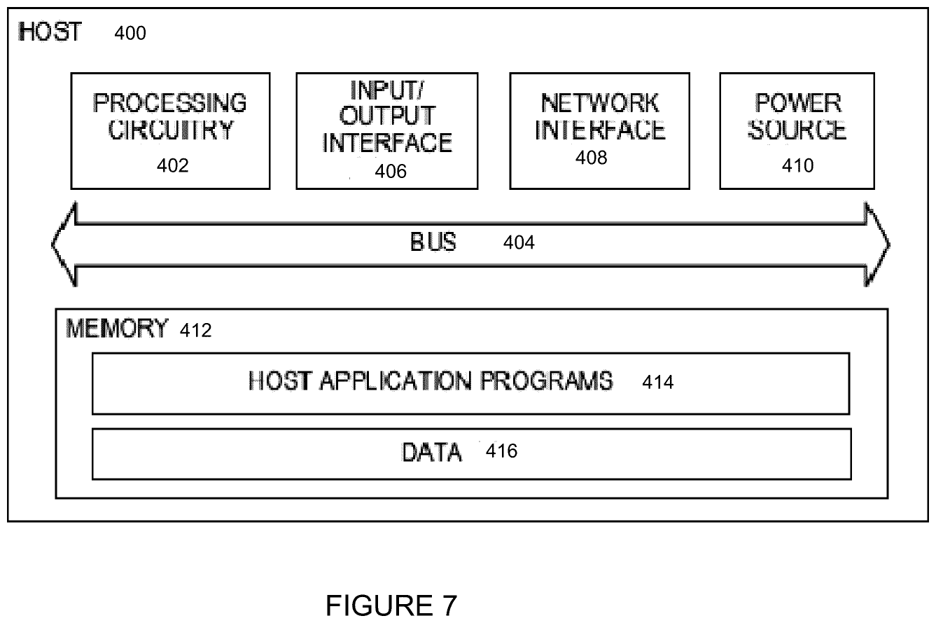

FIG. 7 is a block diagram of a host 400, which may be an embodiment of the host 116 of FIG. 4, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

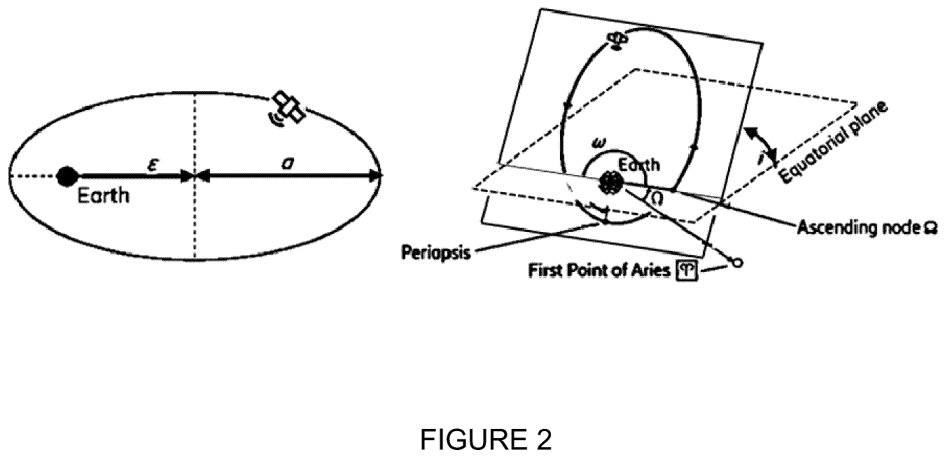

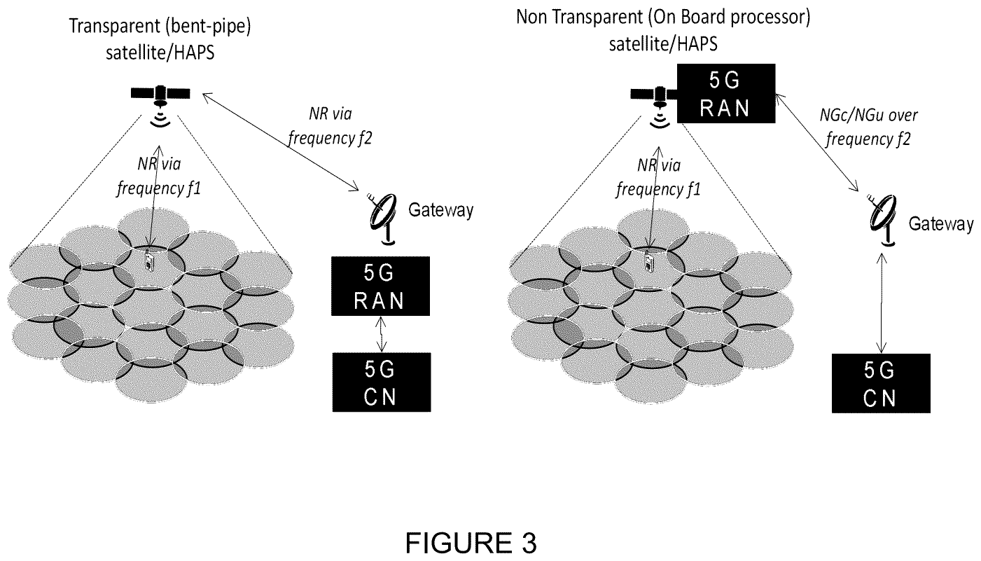

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

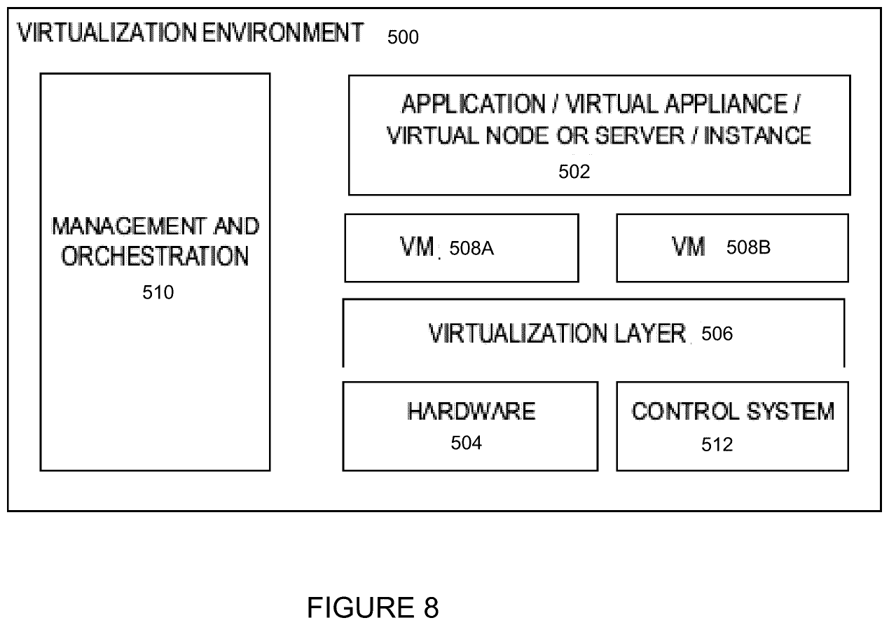

FIG. 8 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

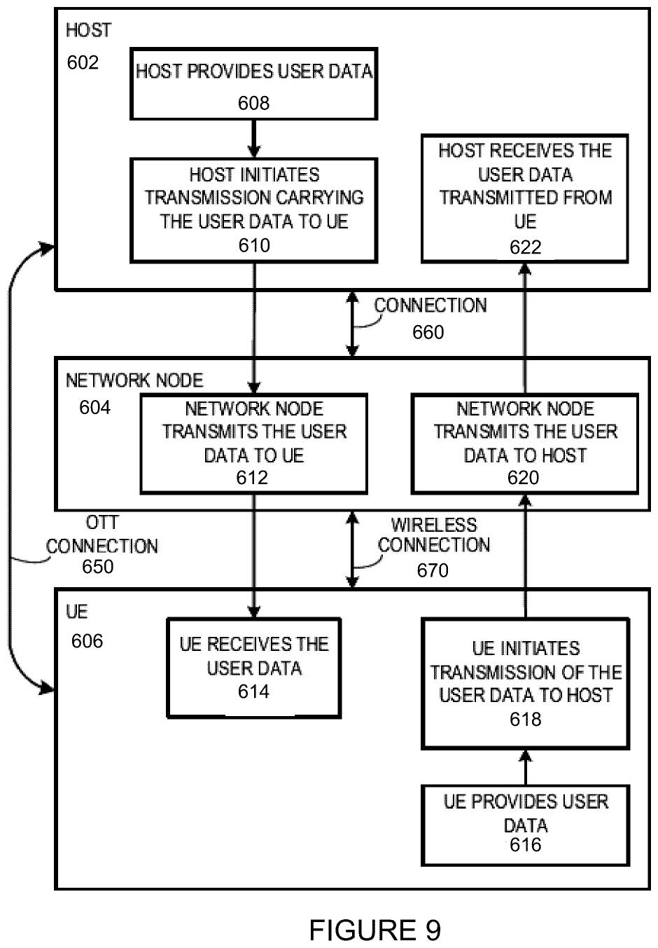

FIG. 9 shows a communication diagram of a host 602 communicating via a network node 604 with a UE 606 over a partially wireless connection in accordance with some embodiments.

Example implementations, in accordance with various embodiments, of the UE (such as a UE 112a of FIG. 4 and/or UE 200 of FIG. 5), network node (such as network node 110a of FIG. 4 and/or network node 300 of FIG. 6), and host (such as host 116 of FIG. 4 and/or host 400 of FIG. 7) discussed in the preceding paragraphs will now be described with reference to FIG. 9.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

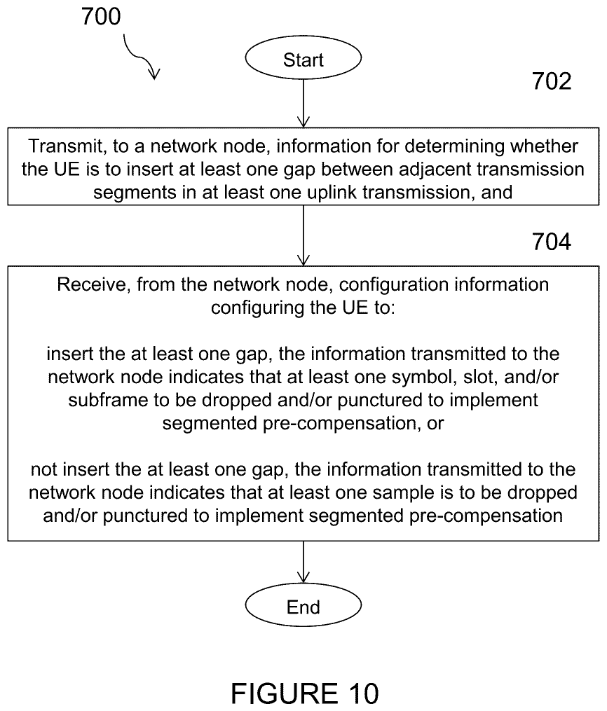

FIG. 10 illustrates an example method 700 by a UE 112, 200 for facilitating long UL transmission in an IoT NTN, according to certain embodiments. The method begins, at step 702, with the UE transmitting, to a network node 110, 300, information for determining whether the UE is to insert at least one gap between adjacent transmission segments in at least one UL transmission. At step 704, the UE 112, 200 receives, from the network node 110, 300, configuration information configuring the UE 112, 200 to insert the at least one gap when the information transmitted to the network node 110, 300 indicates that at least one symbol, slot, and/or subframe is to be dropped and/or punctured to implement segmented pre-compensation. Alternatively, the configuration information configures the UE 112, 200 to not insert the at least one gap when the information transmitted to the network node 110, 300 indicates that at least one sample is to be dropped and/or punctured to implement segmented pre-compensation.

In a particular embodiment, when the UE is to insert the at least one gap the information indicates that the UE is a Type-A UE or when the UE is not to insert the at least one gap the information indicates that the UE is a Type-B UE.

In a particular embodiment, when the UE is to insert the at least one gap, the information indicates a gap duration or a range of gap durations that can be inserted between the adjacent transmission segments.

In a particular embodiment, when the UE is to insert the at least one gap, the information indicates a number of symbols, slots, and/or subframes to be dropped and/or punctured to implement segmented pre-compensation.

In a particular embodiment, the information comprises capability information associated with the UE.

In a particular embodiment, the UE is to insert the at least one gap, and the information indicates that the at least one gap is to be inserted for a particular type of transmission and/or a particular type of physical channel.

In a particular embodiment, the particular type of physical channel is a PUSCH, PUCCH, or (N)PUSCH.

In a particular embodiment, when the UE is to insert the at least one gap, the information indicates that the at least one gap is to be inserted between the adjacent transmission segments for each transmission having a duration above a threshold duration or that the at least one gap is to be inserted between the adjacent transmission segments for each transmission having a particular duration.

In a particular embodiment, the information indicates a particular type of NTN and the configuration information configures the UE to insert the at least one gap between the adjacent transmission segments for each transmission associated with the particular type of NTN.

In a particular embodiment, the particular type of the NTN is low earth orbit or medium earth orbit.

In a particular embodiment, the information indicates a timing advance, and the UE inserts the at least one gap between adjacent transmission segments in at least one uplink transmission when the timing advance is increasing, or the UE determines not to insert the at least one gap between adjacent transmission segments in the at least one uplink transmission when the timing advance is decreasing.

In a particular embodiment, the information indicates a position of the UE.

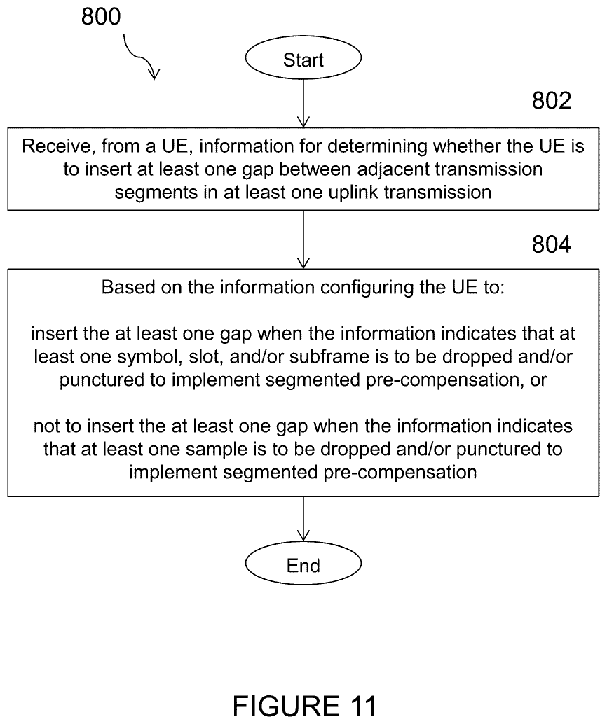

FIG. 11 illustrates an example method 800 by a network node 110, 300 for facilitating long UL transmission in an IoT NTN, according to certain embodiments. The method includes the network node 110, 300 receiving, at step 802 and from a UE (112, 200) information for determining whether the UE is to insert at least one gap between adjacent transmission segments in at least one uplink transmission. At step 804, based on the information, the network node 110, 300 configures the UE to insert the at least one gap when the information indicates that at least one symbol, slot, and/or subframe to be dropped and/or punctured to implement segmented pre-compensation. Alternatively, the network node 110, 300 configures the UE not to insert the at least one gap when the information indicates that at least one sample is to be dropped and/or punctured to implement segmented pre-compensation.

In a particular embodiment, the network node 110, 300 determines that the UE is a Type-A UE when the information indicates that the UE is to insert the at least one gap, or the network node determines that the UE is a Type-B UE when the information indicates that the UE is not to insert the at least one gap.

In a particular embodiment, when the UE is to insert the at least one gap, the information indicates a gap duration or a range of gap durations to be inserted between the adjacent transmission segments.

In a particular embodiment, when the UE is to insert the at least one gap, the information indicates a number of symbols, slots, and/or subframes to be dropped and/or punctured to implement segmented pre-compensation.

In a particular embodiment, the information comprises capability information associated with the UE.

In a particular embodiment, the information indicates a particular type of transmission and/or a particular type of physical channel, and the network node determines that the at least one gap will be inserted between the adjacent transmission segments based on the particular type of transmission and/or the particular type of physical channel.

In a particular embodiment, the particular type of physical channel is a PUSCH, PUCCH, or (N)PUSCH.

In a particular embodiment, the information comprises a duration, and the network node determines that the at least one gap will be inserted between the adjacent transmission segments for each transmission having a duration above a threshold duration, or the network node determines that the at least one gap will be inserted between the adjacent transmission segments for each transmission having the particular duration.

In a particular embodiment, the information indicates a particular type of NTN, and the network node determines that the at least one gap will be inserted between the adjacent transmission segments for each transmission associated with the particular type of NTN.

In a particular embodiment, the particular type of the NTN is low earth orbit or medium earth orbit.

In a particular embodiment, the information indicates a timing advance, and the network node determines that the at least one gap will be inserted between adjacent transmission segments in at least one uplink transmission when the timing advance is increasing, or the network node determines that the at least one gap will not be inserted between adjacent transmission segments in the at least one uplink transmission when the timing advance is decreasing.

In a particular embodiment, the information indicates a position of the UE.

### EXAMPLE EMBODIMENTS

### Group A Example Embodiments

Example Embodiment A1. A method by a user equipment for facilitating long uplink transmission in IoT NTN, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for facilitating long uplink transmission in IoT NTN, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for facilitating long uplink transmission in IoT NTN, the method comprising: communicating, with a network node, information for determining whether the UE is to insert at least one gap between adjacent transmission segments in at least one uplink transmission.

Example Embodiment C2a. The method of Example Embodiment C1, wherein communicating the information comprises transmitting the information to the network node.

Example Embodiment C2b. The method of any one of Example Embodiments C1 to C2a, wherein the information indicates that the UE is a Type-A UE or a Type-B UE.

Example Embodiment C3. The method of Example Embodiment C1, wherein communicating the information comprises receiving the information from the network node.

Example Embodiment C4. The method of any one of Example Embodiments C1 to C3, wherein the information indicates a gap duration or a range of gap durations to be inserted between the adjacent transmission segments.

Example Embodiment C5. The method of any one of Example Embodiments C1 to C4, wherein the information indicates a number of samples, symbols, slots, subframes, and/or resource units to be dropped and/or punctured to implement segmented pre-compensation.

Example Embodiment C6. The method of any one of Example Embodiments C1 to C5, wherein the information comprises capability information associated with the UE.

Example Embodiment C7. The method of any one of Example Embodiments C1 to C6, wherein the information indicates that the at least one gap is to be inserted for a particular type of transmission and/or a particular type of physical channel.

Example Embodiment C8. The method of any one of Example Embodiments C1 to C7, wherein the information indicates that the at least one gap is to be inserted between the adjacent transmission segments for each transmission having a duration above a threshold duration.

Example Embodiment C9. The method of any one of Example Embodiments C1 to C8, wherein the information indicates that the at least one gap is to be inserted between the adjacent transmission segments for each transmission having a particular duration.

Example Embodiment C10. The method of any one of Example Embodiments C1 to C9, wherein the information indicates that the at least one gap is to be inserted between the adjacent transmission segments for each transmission having a particular duration.

Example Embodiment C11. The method of any one of Example Embodiments C1 to C10, wherein the information indicates a particular type of NTN, and the UE is configured to insert the at least one gap between the adjacent transmission segments for each transmission associated with the particular type of NTN.

Example Embodiment C12. The method of any one of Example Embodiments C1 to C11, wherein the information indicates a timing advance.

Example Embodiment C13. The method of Example Embodiment C12, wherein the UE is configured to insert the at least one gap between adjacent transmission segments in at least one uplink transmission based on whether a timing advance is increasing or decreasing.

Example Embodiment C14. The method of any one of Example Embodiments C1 to C13, wherein the information indicates a position of the UE.

Example Embodiment C15. The method of Example Embodiment C14, further comprising: determining whether a timing advance associated with the UE is increasing or decreasing based on the position of the UE, and wherein the UE is configured to insert the at least one gap between adjacent transmission segments in at least one uplink transmission based on whether the timing advance is increasing or decreasing.

Example Embodiment C16. The method of any one of Example Embodiments C12 to C15, wherein the UE is configured to insert the at least one gap between the adjacent transmission segments in the at least one uplink transmission when the timing advance is increasing, and wherein the UE is configured to not insert the at least one gap between the adjacent transmission segments in the at least one uplink transmission when the timing advance is non-increasing or decreasing.

Example Embodiment C17. The method of Example Embodiments C1 to C16, further comprising: providing user data; and forwarding the user data to a host via the transmission to the network node.

Example Embodiment C18. A user equipment comprising processing circuitry configured to perform any of the methods of Example Embodiments C1 to C17.

Example Embodiment C19. A wireless device comprising processing circuitry configured to perform any of the methods of Example Embodiments C1 to C17.

Example Embodiment C20. A computer program comprising instructions which when executed on a computer perform any of the methods of Example Embodiments C1 to C17.

Example Embodiment C21. A computer program product comprising computer program, the computer program comprising instructions which when executed on a computer perform any of the methods of Example Embodiments C1 to C17.

Example Embodiment C22. A non-transitory computer readable medium storing instructions which when executed by a computer perform any of the methods of Example Embodiments C1 to C17.

### Group D Example Embodiments

Example Embodiment D1. A method by a network node for facilitating long uplink transmission in IoT NTN, the method comprising: communicating, with a user equipment (UE), information for determining whether the UE is to insert at least one gap between adjacent transmission segments in at least one uplink transmission.

Example Embodiment D2a. The method of Example Embodiment D1, wherein communicating the information comprises receiving the information from the UE.

Example Embodiment D2b. The method of any one of Example Embodiments D1 to D2a, wherein the information indicates that the UE is a Type-A UE or a Type-B UE.

Example Embodiment D3. The method of Example Embodiment D1, wherein communicating the information comprises transmitting the information to the UE.

Example Embodiment D4. The method of any one of Example Embodiments D1 to D3, wherein the information indicates a gap duration or a range of gap durations to be inserted between the adjacent transmission segments.

Example Embodiment D5. The method of any one of Example Embodiments D1 to D4, wherein the information indicates a number of samples, symbols, slots, subframes, and/or resource units to be dropped and/or punctured to implement segmented pre-compensation.

Example Embodiment D6. The method of any one of Example Embodiments D1 to D5, wherein the information comprises capability information associated with the UE.

Example Embodiment D7. The method of any one of Example Embodiments D1 to D6, wherein the information indicates a particular type of transmission and/or a particular type of physical channel, and the method further includes determining that the at least one gap will be inserted between the adjacent transmission segments based on the particular type of transmission and/or the particular type of physical channel.

Example Embodiment D8. The method of any one of Example Embodiments D1 to D7, wherein the information comprises a duration, and the method further comprises determining that the at least one gap will be inserted between the adjacent transmission segments for each transmission having a duration above a threshold duration.

Example Embodiment D9. The method of any one of Example Embodiments D1 to D7, wherein the information comprises a duration, and the method further comprises determining that the at least one gap will be inserted between the adjacent transmission segments for each transmission having the particular duration.

Example Embodiment D10. The method of any one of Example Embodiments D1 to D9, wherein the information indicates that the UE is to insert the at least one gap between the adjacent transmission segments for each transmission having a particular duration.

Example Embodiment D11. The method of any one of Example Embodiments D1 to D10, wherein the information indicates a particular type of NTN, and the method further comprises determining that the at least one gap will be inserted between the adjacent transmission segments for each transmission associated with the particular type of NTN.

Example Embodiment D12. The method of any one of Example Embodiments D1 to D1, wherein the information indicates a timing advance.

Example Embodiment D13. The method of Example Embodiment D12, further comprising: determining whether the timing advance is increasing or decreasing, and determining that the at least one gap will be inserted between adjacent transmission segments in at least one uplink transmission based on whether the timing advance is increasing or decreasing.

Example Embodiment D14. The method of any one of Example Embodiments D1 to D13, wherein the information indicates a position of the UE.

Example Embodiment D15. The method of Example Embodiment D14, further comprising: determining whether a timing advance associated with the UE is increasing or decreasing based on the position of the UE, and determining whether the at least one gap will be inserted between adjacent transmission segments in at least one uplink transmission based on whether the timing advance is increasing or decreasing.

Example Embodiment D16. The method of any one of Example Embodiments D12 to D15, wherein the UE is configured to insert the at least one gap between the adjacent transmission segments in the at least one uplink transmission when the timing advance is increasing, and wherein the UE is configured not to insert the at least one gap between the adjacent transmission segments in the at least one uplink transmission when the timing advance is non-increasing or decreasing.

Example Embodiment D17. The method of any one of Example Embodiments D1 to D16, wherein the network node comprises a gNodeB (gNB).

Example Embodiment D18. The method of any of the previous Example Embodiments, further comprising: obtaining user data; and forwarding the user data to a host or a user equipment.

Example Embodiment D19. A network node comprising processing circuitry configured to perform any of the methods of Example Embodiments D1 to D18.

Example Embodiment D20. A computer program comprising instructions which when executed on a computer perform any of the methods of Example Embodiments D1 to D18.

Example Embodiment D21. A computer program product comprising computer program, the computer program comprising instructions which when executed on a computer perform any of the methods of Example Embodiments D1 to D18.

Example Embodiment D22. A non-transitory computer readable medium storing instructions which when executed by a computer perform any of the methods of Example Embodiments D1 to D18.

### Group E Example Embodiments

Example Embodiment E1. A user equipment for facilitating long uplink transmission in IoT NTN, the user equipment comprising: processing circuitry configured to perform any of the steps of any of the Group A and C Example Embodiments; and power supply circuitry configured to supply power to the processing circuitry.

Example Embodiment E2. A network node for facilitating long uplink transmission in IoT NTN, the network node comprising: processing circuitry configured to perform any of the steps of any of the Group B and D Example Embodiments; power supply circuitry configured to supply power to the processing circuitry.

Example Embodiment E3. A user equipment (UE) for facilitating long uplink transmission in IoT NTN, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C

Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

### Group F Example Embodiments

Example Embodiment F1. A method by a user equipment (UE) for facilitating long uplink transmission in eMTC NTN, the method comprising: receiving, from a network node, information indicating a transmission segment duration.

Example Embodiment F2. The method of Example Embodiment F1, wherein the transmission segment duration comprises a maximum number of repetitions for at least one transmission segment.

Example Embodiment F3. The method of any one of Example Embodiments F1 to F2, wherein the at least one transmission segment is for transmission on a physical uplink control channel (PUCCH).

Example Embodiment F4. The method of Example Embodiment F1, wherein the PUCCH comprises an eMTC PUCCH.

Example Embodiment F5. The method of any one of Example Embodiments F1 to F4, wherein the information indicates at least one K value for the transmission segment duration using a k-bit field, where the values are different depending on the CE mode: CE mode A: 1-bit field is used to indicate K=2 candidate values: {2, 4} (unit: subframes), and/or CE mode B: 3-bit field is used to indicate K=5 candidate values: {4, 8, 16, 32, 64} (unit: subframes).

Example Embodiment F6. The method of any one of Example Embodiments F1 to F5, wherein the information does not indicate a value for the transmission segment duration for a PUCCH.

Example Embodiment F7. The method of Example Embodiment F6, further comprising determining not to perform segmented pre-compensation for the at least one transmission segment based on the information not indicating a value for the transmission segment duration for the PUCCH.

Example Embodiment F8. The method of any one of Example Embodiments F1 to F5, wherein the information indicates a value for the transmission segment duration for a PUCCH.

Example Embodiment F9. The method of Example Embodiment F8, further comprising performing segmented pre-compensation for the at least one transmission segment based on the information indicating the value for the transmission segment duration for the PUCCH.

Example Embodiment F10. The method of any one of Example Embodiments F1 to F9, further comprising, based on the information, determining not to perform segmented pre-compensation for the at least one transmission segment for the PUCCH.

Example Embodiment F11. The method of Example Embodiment F10, wherein the information indicates at least one K value for the transmission segment duration using a k-bit field, where the values are different depending on the CE mode: CE mode A: 2-bit field is used to indicate K=3 candidate values: {2, 4, 8} (unit: subframes); or CE mode B: 3-bit field is used to indicate K=6 candidate values: {4, 8, 16, 32, 64, 128} (unit: subframes).

Example Embodiment F12. The method of any one of Example Embodiments F1 to F11, further comprising: determining that a frequency hopping time interval is smaller than the transmission segment duration, and adjusting an uplink transmit timing and/or an uplink frequency for the at least one transmission segment while retuning from a first narrowband to a second narrowband.

Example Embodiment F13. The method of Example Embodiment F12, further comprising determining not to insert a gap between adjacent transmission segments based on the frequency hopping time interval being smaller than the transmission segment duration.

Example Embodiment F14. The method of any one of Example Embodiments F1 to F11, further comprising: receiving configuration information from the network node, based on the configuration information, determining whether to adjust a transmit timing and/or frequency at each frequency hopping instance, and based on the configuration information, determining whether to insert a gap between adjacent transmission segments.

Example Embodiment F15. The method of Example Embodiment F14, wherein the configuration information is received via RRC signaling.

Example Embodiment F16. The method of any one of Example Embodiments F12 to F15, wherein the transmission segment(s) is/are for transmission on a physical uplink control channel (PUCCH), a physical uplink shared channel (PUSCH), or a Physical Random Access Channel (PRACH).

Example Embodiment F17. The method of Example Embodiments F1 to F16, further comprising: providing user data; and forwarding the user data to a host via the transmission to the network node.

Example Embodiment F18. A user equipment comprising processing circuitry configured to perform any of the methods of Example Embodiments F1 to F17.

Example Embodiment F19. A wireless device comprising processing circuitry configured to perform any of the methods of Example Embodiments F1 to F17.

Example Embodiment F20. A computer program comprising instructions which when executed on a computer perform any of the methods of Example Embodiments F1 to F17.

Example Embodiment F21. A computer program product comprising computer program, the computer program comprising instructions which when executed on a computer perform any of the methods of Example Embodiments F1 to F17.

Example Embodiment F22. A non-transitory computer readable medium storing instructions which when executed by a computer perform any of the methods of Example Embodiments F1 to F17.

### Group G Example Embodiments

Example Embodiment G1. A method by a network node for facilitating long uplink transmission in eMTC NTN, the method comprising: transmitting, to a user equipment (UE), information indicating a transmission segment duration.

Example Embodiment G2. The method of Example Embodiment G1, wherein the transmission segment duration comprises a maximum number of repetitions for at least one transmission segment.

Example Embodiment G3. The method of any one of Example Embodiments G1 to G2, wherein the at least one transmission segment is for transmission on a physical uplink control channel (PUCCH).

Example Embodiment G4. The method of Example Embodiment G1, wherein the PUCCH comprises an eMTC PUCCH.

Example Embodiment G5. The method of any one of Example Embodiments G1 to G4, wherein the information indicates at least one K value for the at least one transmission segment duration using a k-bit field, where the values are different depending on the CE mode: CE mode A: 1-bit field is used to indicate K=2 candidate values: {2, 4} (unit: subframes), and/or CE mode B: 3-bit field is used to indicate K=5 candidate values: {4, 8, 16, 32, 64} (unit: subframes).

Example Embodiment G6. The method of any one of Example Embodiments G1 to G5, wherein the information does not indicate a value for the at least one transmission segment duration for a PUCCH.

Example Embodiment G7. The method of Example Embodiment G6, further comprising configuring the UE not to perform segmented pre-compensation for the at least one transmission segment based on the information not indicating a value for the transmission segment duration for the PUCCH.

Example Embodiment G8. The method of any one of Example Embodiments G1 to G5, wherein the information indicates a value for the transmission segment duration for a PUCCH.

Example Embodiment G9. The method of Example Embodiment G8, further comprising configuring the UE to perform segmented pre-compensation for the at least one transmission segment based on the information indicating the value for the transmission segment duration for the PUCCH.

Example Embodiment G10. The method of any one of Example Embodiments G1 to G9, further comprising configuring the UE to determine not to perform segmented pre-compensation for an uplink transmission for the PUCCH based on the information.

Example Embodiment G11. The method of Example Embodiment G10, wherein the information indicates at least one K value for the at least one transmission segment duration using a k-bit field, where the values are different depending on the CE mode: CE mode A: 2-bit field is used to indicate K=3 candidate values: {2, 4, 8} (unit: subframes); and/or CE mode B: 3-bit field is used to indicate K=6 candidate values: {4, 8, 16, 32, 64, 128} (unit: subframes).

Example Embodiment G12. The method of any one of Example Embodiments G1 to G11, wherein a frequency hopping time interval is smaller than the transmission segment duration, and the method further comprises configuring the UE to adjust an uplink transmit timing and/or an uplink frequency while retuning from a first narrowband to a second narrowband.

Example Embodiment G13. The method of Example Embodiment G12, further comprising configuring the UE not to insert a gap between adjacent transmission segments based on the frequency hopping time interval being smaller than the transmission segment duration.

Example Embodiment G14. The method of any one of Example Embodiments G1 to G11, further comprising: transmitting configuration information to the UE, and wherein the UE is configured to determine, based on the configuration information, whether to adjust a transmit timing and/or frequency at each frequency hopping instance, and wherein the UE is configured to determine, based on the configuration information, whether to insert a gap between adjacent transmission segments.

Example Embodiment G15. The method of Example Embodiment G14, wherein the configuration information is transmitted via RRC signaling.

Example Embodiment G16. The method of any one of Example Embodiments G12 to G15, wherein the transmission segment(s) is/are for transmission on a physical uplink control channel (PUCCH), a physical uplink shared channel (PUSCH), or a Physical Random Access Channel (PRACH).

Example Embodiment G17. The method of any one of Example Embodiments G1 to G16, wherein the network node comprises a gNodeB (gNB).

Example Embodiment G18. The method of any of the previous Example Embodiments, further comprising: obtaining user data; and forwarding the user data to a host or a user equipment. Example Embodiment G19. A network node comprising processing circuitry configured to perform any of the methods of Example Embodiments G1 to G18.

Example Embodiment G20. A computer program comprising instructions which when executed on a computer perform any of the methods of Example Embodiments G1 to G18.

Example Embodiment G21. A computer program product comprising computer program, the computer program comprising instructions which when executed on a computer perform any of the methods of Example Embodiments G1 to G18.

Example Embodiment G22. A non-transitory computer readable medium storing instructions which when executed by a computer perform any of the methods of Example Embodiments G1 to G18.

### Additional Information

Transmission Segment Duration for eMTC PUCCH

Similar to eMTC PUSCH/PRACH, the network should be able to configure a transmission segment duration for PUCCH such that a timing accuracy of at least 12*T_{S}=0.39 μs (Table 7.26.2-1 in TS 36.133) is supported assuming the worst-case scenario where the TA drift is ˜100 μs/s and the elevation angle is small. It may be noted that a longer transmission segment duration will suffice for a more favorable TA drift or elevation angle, etc.

Transmission segment durations for eMTC PUCCH are provided in Table 5 below. It is noted that the maximum transmission duration for PUCCH is 8 ms for CE mode A and 128 ms for CE mode B, which are both smaller than 256 ms. Therefore, unlike eMTC PUSCH, we do not need to support a transmission segment duration of up to 256 ms. The lower limit is selected to meet a timing error requirement of 0.39 μs. For the upper limit, it is sufficient to support the maximum possible segment duration. For example, for CE mode A with 8 repetitions configured for PUCCH, the maximum transmission segment can consist of 4 repetitions.

TABLE 5
Transmission segment duration for eMTC PUCCH.

| | Basic rep. | | |
|---|---|---|---|
| | unit | No. of | Transmission segment duration |
| CE mode | duration | repetitions | (unit: no. of repetitions) |
| A | 1 ms | 1, 2, 4, 8 | 2, 4 |
| B | 1 ms | 4, 8, 16, | 4, 8, 16, 32, 64 |
| | | 32, 64, | |
| | | 128 | |

In a particular embodiment, for eMTC PUCCH, the network configures one of the K values for the uplink transmission segment duration using a k-bit field, where the values are different depending on the CE mode:
CE mode A: 1-bit field is used to indicate K=2 candidate values: {2, 4} (unit: subframes)
CE mode B: 3-bit field is used to indicate K=5 candidate values: {4, 8, 16, 32, 64} (unit: subframes)

In another particular embodiment, if the network does not intend to configure segmented pre-compensation for PUCCH, it does not indicate any value for transmit segment duration in SI or in UE-specific RRC signalling.

In another particular embodiment, the UE does not need to perform segmented pre-compensation for uplink transmission on PUCCH if the network has not indicated any value for transmit segment duration in SI or in UE-specific RRC signalling.

In the previous embodiments, when the network does not want to configure segmented precompensation for the uplink, it implicitly indicated this information to the UE. Alternatively, the network can explicitly indicate this to the UE by adding another value for the transmission segment duration.

In a particular embodiment, for eMTC PUCCH, the network configures one of the K values for the uplink transmission segment duration using a k-bit field, where the values are different depending on the CE mode:
CE mode A: 2-bit field is used to indicate K=3 candidate values: {2, 4, 8} (unit: subframes)
CE mode B: 3-bit field is used to indicate K=6 candidate values: {4, 8, 16, 32, 64, 128} (unit: subframes)

In a further particular embodiment, if the transmission segment duration for PUCCH is set to 8 subframes for CE mode A (or to 128 subframes for CE mode B), the UE does not need to perform segmented pre-compensation for PUCCH.

eMTC Frequency Hopping and Pre-Compensation Gap

In eMTC, frequency hopping is always activated for PUCCH and can also be configured by the network for PUSCH/PRACH. If the frequency hopping time interval is smaller than the configured transmission segment duration, the UE can adjust the uplink transmit timing and frequency while retuning to a different narrowband. To facilitate frequency hopping, eMTC allows a frequency retuning gap of up to 2 SC-FDMA uplink symbols between adjacent narrowbands.

In one embodiment, if frequency hopping is activated for an uplink channel and the frequency hopping time interval is set to be smaller than the transmission segment duration by the network, the UE is allowed to adjust its transmit timing and frequency at each frequency hopping instance and the UE is not allowed to insert a gap between transmission segments. This is because the UE can adjust its timing using the existing narrowband retuning time period of up to 2 SC-FDMA uplink symbols between adjacent narrowbands.

Example: Frequency hopping is always active for LTE-M PUCCH. The network configures a frequency hopping time interval from [1, 2, 4, 8] (ms) for CE mode A or from [2, 4, 8, 16] (ms) for CE-mode B. If the configured hopping interval for PUCCH is smaller than the configured transmission segment duration for PUCCH, a type-A or a type-B UE can adjust its timing/frequency when it hops to a different narrowband using the retuning gap for frequency hopping and no additional gap needs to be inserted between transmission segments.

In another embodiment, network configures the following UE behaviors by RRC for frequency hopping:
If configured, the UE adjusts its transmit timing and frequency at each frequency hopping instance and the UE does not insert a gap between adjacent transmission segments.
If configured, the UE adjusts its transmit timing and frequency at each frequency hopping instance and the UE inserts a gap between adjacent transmission segments.
Otherwise, the UE inserts a gap between adjacent transmission segments and UE does not adjust its transmit timing and frequency at each frequency hopping instance.

1.-28. (canceled)

29. A method by a user equipment, UE, for facilitating long uplink transmission in an Internet of Things, IoT, Non-Terrestrial Network, NTN, the method comprising:
transmitting, to a network node, information for determining whether the UE is to insert at least one gap between adjacent transmission segments in at least one uplink transmission, and
receiving, from the network node, configuration information configuring the UE to:
insert the at least one gap when the information transmitted to the network node indicates that at least one symbol, slot, and/or subframe is to be dropped and/or punctured to implement segmented pre-compensation, and
not insert the at least one gap when the information transmitted to the network node indicates that at least one sample is to be dropped and/or punctured to implement segmented pre-compensation.

30. The method of claim 29, wherein when the UE is to insert the at least one gap the information indicates that the UE is a Type-A UE or when the UE is not to insert the at least one gap the information indicates that the UE is a Type-B UE.

31. The method of claim 29, wherein, when the UE is to insert the at least one gap, the information indicates a gap duration or a range of gap durations that can be inserted between the adjacent transmission segments.

32. The method of claim 29, wherein, when the UE is to insert the at least one gap, the information indicates a number of symbols, slots, and/or subframes to be dropped and/or punctured to implement segmented pre-compensation.

33. The method of claim 29, wherein the information comprises capability information associated with the UE.

34. The method of claim 29, wherein, when the UE is to insert the at least one gap, the information indicates that the at least one gap is to be inserted for a particular type of transmission and/or a particular type of physical channel.

35. The method of claim 34, wherein the particular type of physical channel is a Physical Uplink Shared Channel, Physical Uplink Control Channel, or Narrowband Physical Uplink Shared Channel.

36. The method of claim 35, wherein, when the UE is to insert the at least one gap, the information indicates:
that the at least one gap is to be inserted between the adjacent transmission segments for each transmission having a duration above a threshold duration, or
that the at least one gap is to be inserted between the adjacent transmission segments for each transmission having a particular duration.

37. The method of claim 29, wherein the information indicates a particular type of NTN and the configuration information configures the UE to insert the at least one gap between the adjacent transmission segments for each transmission associated with the particular type of NTN.

38. The method of claim 37, wherein the particular type of the NTN is low earth orbit or medium earth orbit.

39. The method of claim 29, wherein the information indicates a timing advance and the method comprises:
inserting the at least one gap between adjacent transmission segments in at least one uplink transmission when the timing advance is increasing; or
determining not to insert the at least one gap between adjacent transmission segments in the at least one uplink transmission when the timing advance is decreasing.

40. A method by a network node for facilitating long uplink transmission in an Internet of Things, IoT, Non-Terrestrial Network, NTN, the method comprising:
receiving, from a user equipment, UE, information for determining whether the UE is to insert at least one gap between adjacent transmission segments in at least one uplink transmission, and
based on the information, configuring the UE to:
insert the at least one gap when the information indicates that at least one symbol, slot, and/or subframe is to be dropped and/or punctured to implement segmented pre-compensation, and
not insert the at least one gap when the information indicates that at least one sample is to be dropped and/or punctured to implement segmented pre-compensation.

41. The method of claim 40, wherein the information indicates a particular type of transmission and/or a particular type of physical channel, and the method further includes determining that the at least one gap will be inserted between the adjacent transmission segments based on the particular type of transmission and/or the particular type of physical channel,
wherein the information comprises capability information associated with the UE and wherein the particular type of physical channel is a Physical Uplink Shared Channel, Physical Uplink Control Channel, or Narrowband Physical Uplink Shared Channel.

42. The method of claim 41, wherein the information comprises a duration, and the method further comprises:
determining that the at least one gap will be inserted between the adjacent transmission segments for each transmission having a duration above a threshold duration, or
determining that the at least one gap will be inserted between the adjacent transmission segments for each transmission having the particular duration.

43. The method of claim 40, wherein the information indicates a timing advance, and the method comprises:
determining that the at least one gap will be inserted between adjacent transmission segments in at least one uplink transmission when the timing advance is increasing; or
determining that the at least one gap will not be inserted between adjacent transmission segments in the at least one uplink transmission when the timing advance is decreasing.

44. A user equipment, UE, for facilitating long uplink transmission in an Internet of Things, IoT, Non-Terrestrial Network, NTN, the UE comprising processing circuitry configured to:
transmit, to a network node, information for determining whether the UE is to insert at least one gap between adjacent transmission segments in at least one uplink transmission, and
receiving, from the network node, configuration information configuring the UE to:
insert the at least one gap when the information transmitted to the network node indicates that at least one symbol, slot, and/or subframe is to be dropped and/or punctured to implement segmented pre-compensation, and
not insert the at least one gap when the information transmitted to the network node indicates that at least one sample is to be dropped and/or punctured to implement segmented pre-compensation.

45. The UE of claim 44, wherein when the UE is to insert the at least one gap the information indicates that the UE is a Type-A UE or when the UE is not to insert the at least one gap the information indicates that the UE is a Type-B UE.
